(19) United States
(12) Patent Application Publication
(10) Pub. No.: US 2026/0331535 A1
(43) Pub. Date: Oct. 22, 2026

(54) POROUS SUPPORT COMPRISED OF INTERNAL REFORMING LAYER OF FUEL CELL AND FUEL CELL COMPRISING THE SAME

(71) Applicant: KOREA INSTITUTE OF SCIENCE AND TECHNOLOGY, Seoul (KR)

(72) Inventors: Sungeun YANG, Seoul (KR); Seongkook OH, Seoul (KR); Jong Heon CHONG, Seoul (KR); Ji-Won SON, Seoul (KR); Jong Ho LEE, Seoul (KR); Kyung Joong YOON, Seoul (KR); Ho-Il JI, Seoul (KR)

(21) Appl. No.: 19/632,893

(22) Filed: Mar. 30, 2026

(30) Foreign Application Priority Data
Apr. 16, 2025 (KR) 10-2025-0049285

(51) Int. Cl. H01M 8/0271; C01B 3/047; H01M 8/0606

(52) U.S. Cl. CPC H01M 8/0271; C01B 3/047; H01M 8/0606; C01B 2203/0227; C01B 2203/067; C01B 2203/1058

(57) ABSTRACT

The present specification relates to a porous support in which an internal reforming layer of a fuel cell is included and a fuel cell comprising the same. A porous support for a fuel cell according to one embodiment of the present invention provides an effect capable of increasing ammonia decomposition performance without introducing an additional catalyst.

### CROSS REFERENCE TO RELATED APPLICATION

The present application claims priority to Korean Patent Application No. 10-2025-0049285, filed Apr. 16, 2025, the entire contents of which are hereby incorporated by this reference.

### BACKGROUND OF THE INVENTION

### Field of the Invention

In the present specification, a porous support in which an internal reforming layer of a fuel cell is included and a fuel cell comprising the same are disclosed.

This invention was carried out with the support of Ministry of Trade, Industry and Energy under a research project of Unique Project identification number: 2410002659 and Project identification number: KP002598 titled “Development of cells and stacks for thin-film based solid oxide fuel cells operating at 500 °C”, as part of the research project of “Development of core technologies for renewable energy (electricity)” managed by Korea Institute of Science and Technology from Jan. 1, 2024 to Dec. 31, 2024.

This invention was carried out with the support of Ministry of Science, Technology & ICT under a research project of Unique Project identification number: 2710008917 and Project identification number: RS-2024-00449780 titled “Interface-engineered low-cost catalyst for distributed ammonia synthesis and utilization”, as part of the research project of “Development of nanomaterial technology” managed by National Research Foundation of Korea from Jul. 1, 2024 to Dec. 31, 2024.

### Description of the Related Art

As a next-generation hydrogen carrier, ammonia is receiving attention. For ammonia, energy density is high and liquefaction is relatively simple, and there is an advantage that an existing ammonia transport infrastructure can be utilized as it is. Methods of utilizing ammonia are diverse. As interest in renewable energy increases, research for driving a fuel cell by reforming ammonia into hydrogen is being actively conducted. A fuel cell is a device that directly converts chemical energy into electrical energy through an electrochemical reaction, and since it has advantages such as eco-friendliness, high energy conversion efficiency, high energy density, scalability by size (scalability), and fuel usability of various types, it is being highlighted as a future alternative energy. Types of the fuel cell are divided based on an electrolyte, and a wide operating temperature range is exhibited. In particular, when a solid oxide fuel cell (SOFC) operating at a high temperature is utilized, ammonia may be directly used as a fuel without a separate reforming process. This is because ammonia has an endothermic reaction characteristic of being decomposed into hydrogen and nitrogen at a high temperature.

Since the solid oxide fuel cell operates at a high temperature of 700 °C or higher, it is advantageous for ammonia decomposition, but problems such as material degradation or durability reduction occur due to high-temperature operation. For these reasons, research on fuel cell development operating at a relatively low temperature is active. However, for the ammonia decomposition reaction, activity is lowered at a low temperature, and for an operation of less than 650 °C, an additional catalyst introduction is required. Accordingly, a technology development capable of increasing ammonia decomposition performance without introducing an additional catalyst is required.

### SUMMARY OF THE INVENTION

An object according to one aspect of the present invention is to provide a porous support for a fuel cell capable of increasing ammonia decomposition performance without introducing an additional catalyst.

In one aspect of the present invention, the present invention provides a porous support for a fuel cell, which comprises an internal reforming layer coupled to an anode of a fuel cell to reform fuel provided to the anode, and has a Ni-BCZYYb skeleton.

In another aspect, the present invention provides a fuel cell, in which an oxygen ion conductive solid oxide fuel cell is formed on the porous support for a fuel cell.

In another aspect, the present invention provides a manufacturing method of the porous support for a fuel cell, comprising: mixing and pulverizing BCZYYb powder, NiO powder, and PMMA powder; pelletizing and pre-sintering the pulverized powder; and screen-printing BCZYYb and NiO paste on the pre-sintered pellet and sintering to obtain a porous support.

A porous support for a fuel cell according to one embodiment of the present invention provides an effect capable of increasing ammonia decomposition performance without introducing an additional catalyst.

### BRIEF DESCRIPTION OF THE DRAWINGS

FIG. 1 is a schematic diagram showing a structure of a fuel cell according to one embodiment of the present invention.

FIG. 2 is a field emission scanning electron microscope (FE-SEM) image of a structure of a fuel cell according to one embodiment of the present invention.

FIG. 3 is a schematic diagram showing an electrochemical performance evaluation and ammonia decomposition performance evaluation method of a fuel cell according to one embodiment of the present invention.

FIGS. 4A, 4B, 4C, and 4D are graphs showing results of evaluating performance of a fuel cell under various fuel conditions according to one embodiment of the present invention.

FIG. 5 is a graph showing long-term driving evaluation results of a fuel cell according to one embodiment of the present invention.

FIG. 6 is a graph showing fuel cell performance evaluation results before and after long-term driving evaluation of a fuel cell according to one embodiment of the present invention.

FIG. 7 is a graph showing ammonia decomposition performance evaluation results of a fuel cell according to one embodiment of the present invention.

### DETAILED DESCRIPTION OF THE INVENTION

Hereinafter, exemplary embodiments of the present invention will be described in detail with reference to the accompanying drawings.

The embodiments of the present invention disclosed herein are illustrated for purposes of description only, and the embodiments of the present invention may be practiced in various forms and should not be interpreted as limiting to the embodiments described herein. The present invention is subject to various modifications and may have various forms, and the embodiments are not intended to limit the present invention to any particular disclosure form, but are to be understood to include all modifications, equivalents, or substitutions that fall within the scope of the teachings and art of the present invention.

Throughout the specification, unless explicitly described to the contrary, the word “comprise” or “include” and variations, such as “comprises”, “comprising”, “includes” or “including”, means the further inclusion of stated constituent elements, not the exclusion of any other constituent elements.

Throughout the specification, the same constituent elements are denoted by the same reference numerals. Throughout the specification, when one component such as a layer, a film, a region, or a plate is described as being positioned “above” or “on” another component, one component can be positioned “directly on another component, and one component can also be positioned on another component with other components interposed therebetween. Throughout the specification, the terms such as “first,” “second,” and other numerical terms may be used herein only to describe various elements, but these elements should not be limited by these terms. These terms are used only to distinguish one constituent element from another constituent element.

### Porous Support for Fuel Cell and Fuel Cell

In one aspect of the present invention, the present invention provides a porous support for a fuel cell, which comprises an internal reforming layer coupled to an anode of a fuel cell to reform fuel provided to the anode, and has a Ni-BCZYYb skeleton.

In the present specification, the porosity refers to a structure having multiple pores in a nanometer-micrometer range.

In the present specification, the skeleton (backbone) refers to a mechanical structure of a material in which an auxiliary material may be deposited, dispersed, or infiltrated.

The BCZYYb of the Ni-BCZYYb represents BaCeₓZr_{1-x-y-z}Y_{y}Yb_{z}O_{3-δ}, where x, y, and z are dopant levels between 0 and 1 and x+y+z<1. δ is an oxygen ion deficiency. In one embodiment, a composition ratio (atomic ratio) of the CZYYb (Ce:Zr:Y:Yb) of the Ni-BCZYYb is 1 to 10:1 to 10:11. In one embodiment, a composition ratio of the BCZYYb (Ba:Ce:Zr:Y:Yb) of the Ni-BCZYYb is 10:4:4:1:1. In one embodiment, the Ni-BCZYYb is Ni-BaCe_{0.4}Zr_{0.4}Y_{0.1}Yb_{0.1}O₃.

In one embodiment, the fuel is ammonia or a gas in which ammonia is partially reformed. The internal reforming layer reforms ammonia, which is the fuel, to decompose it into nitrogen and hydrogen. The ammonia may also be used by being partially reformed.

In one embodiment, the internal reforming layer does not include an additional catalyst other than Ni-BCZYYb.

In another aspect, the present invention includes a fuel cell, in which an oxygen ion conductive solid oxide fuel cell is formed on the porous support for a fuel cell. The present inventors completed the present invention by perceiving that ammonia decomposition performance may be increased without introducing an additional catalyst by improving a material of an internal reforming layer included in a fuel cell.

In one embodiment, the fuel cell is a low-temperature operation type thin-film fuel cell formed by a thin-film deposition technology, but is not limited to the thin-film deposition technology.

In the solid oxide fuel cell, an anode, an electrolyte layer, and a cathode are sequentially formed, and an internal reforming layer for reforming fuel is formed on one surface of the anode. In the solid oxide fuel cell, water may be generated by a reaction between hydrogen supplied to an anode and oxygen ions, or nitrogen and water may be generated by a reaction of ammonia with oxygen ions, and oxygen ions are generated by a reduction reaction of oxygen at a cathode, and the generated oxygen ions move to the anode through an electrolyte. In this case, since electrons are generated at the anode and electrons are consumed at the cathode, a current may be generated by connecting the two electrodes to each other.

The anode of the solid oxide fuel cell may include an inorganic material having oxygen ion conductivity. One or more of nickel (Ni)-based, zirconia (ZrO₂)-based, ceria (CeO₂)-based, and perovskite-based may be included. A type of the inorganic material is not particularly limited, but the inorganic material may include at least one of yttria-stabilized zirconia (YSZ: (Y₂O₃)ₓ(ZrO₂)₁₋ₓ, x=0.05 ~0.15), scandia-stabilized zirconia (ScSZ: (Sc₂O₃)ₓ(ZrO₂)₁₋ₓ, x=0.05~0.15), samarium-doped ceria (SDC: (Sm₂O₃)ₓ(CeO₂)₁₋ₓ, x=0.02~0.4), and gadolinium-doped ceria (GDC: (Gd₂O₃)ₓ(CeO₂)₁₋ₓ, x=0.02~0.4).

The electrolyte layer of the solid oxide fuel cell may include an oxygen ion conductive electrolyte. The electrolyte layer may include one or more of a zirconia (ZrO₂)-based compound and a barium (Ba)-based perovskite compound.

The cathode of the solid oxide fuel cell may include an inorganic material having oxygen ion conductivity so as to be applicable to a cathode for a solid oxide fuel cell. A type of the inorganic material is not particularly limited, but the inorganic material may include at least one of yttria-stabilized zirconia (YSZ: (Y₂O₃)ₓ(ZrO₂)₁₋ₓ, x=0.05~0.15), scandia-stabilized zirconia (ScSZ: (Sc₂O₃)ₓ(ZrO₂)₁₋ₓ, x=0.05~0.15), samarium-doped ceria (SDC: (Sm₂O₃)ₓ(CeO₂)₁₋ₓ, x=0.02~0.4), gadolinium-doped ceria (GDC: (Gd₂O₃)x(CeO₂)₁₋ₓ, x=0.02~0.4), lanthanum strontium manganese oxide (LSM), lanthanum strontium cobalt ferrite (LSCF), lanthanum strontium nickel ferrite (LSNF), lanthanum calcium nickel ferrite (LCNF), lanthanum strontium cobalt oxide (LSC), gadolinium strontium cobalt oxide (GSC), lanthanum strontium ferrite (LSF), samarium strontium cobalt oxide (SSC), barium strontium cobalt ferrite (BSCF), and lanthanum strontium gallium magnesium oxide (LSGM).

### Manufacturing Method of Porous Support for Fuel Cell

In another aspect, the present invention provides a manufacturing method of the porous support for a fuel cell, comprising: mixing and pulverizing BCZYYb powder, NiO powder, and PMMA powder; pelletizing and pre-sintering the pulverized powder; and screen-printing BCZYYb and NiO paste on the pre-sintered pellet and sintering to obtain a porous support.

In one embodiment, in addition to the process of forming and sintering a pellet as described above, a porous support may be manufactured by a ceramic processing method such as a tape casting technique.

In one embodiment, a mixing ratio of the BCZYYb powder, NiO powder, and PMMA powder is 1:1: 0.5 to 1.5 based on weight. Preferably, it is 32:32: 36.

Hereinafter, the present invention will be described in detail with reference to preferred embodiments so that those skilled in the technical field to which the present invention pertains may easily carry out the same. However, the present invention may be implemented in various different forms and is not limited to the embodiments described herein.

### EXAMPLES

### <Manufacturing Example 1>Manufacture of Porous Support for Fuel Cell

BCZYYb 4411 (BaCe_{0.4}Zr_{0.4}Y_{0.1}Yb_{0.1}O₃) powder having a composition ratio of BCZYYb (Ba: Ce: Zr: Y: Yb) of 10:4: 4: 1: 1, NiO powder, and PMMA powder were mixed at a ratio of 32:32:36 and were evenly mixed for 24 hours using a ball milling machine.

Subsequently, the powder was put into a 30 Φ mold and pelletized with a uni-axis press, and then pre-sintered at 950 °C for 3 hours.

Subsequently, 50 vol % BCZYYb and NiO paste were screen-printed on the pellet, and sintered at 1400 °C for 4 hours, so that a substrate including a porous support for a fuel cell (Ni-BCZYYb 4411 substrate) was manufactured.

### <Manufacturing Example 2>Manufacture of Fuel Cell Including Internal Reforming Layer

A thin-film SOFC layer was stacked by PLD on the Ni-BCZYYb 4411 substrate, which is an internal reforming layer for direct ammonia fuel cell driving.

More specifically, an anode was deposited on the substrate by a pulsed laser deposition (PLD) method using a 40 vol % Ni-GDC target (Ni-Gd_{0.1}Ce_{0.9}O_{1.95}) sintered at 1400 °C (700 °C, 3 hours). The substrate deposited using the 40 vol % Ni-GDC target was sintered at 1200 °C for 1 hour to form a stable structure. An electrolyte was deposited by the PLD method using GDC and yttria-stabilized zirconia (YSZ) targets sintered at 1400 °C (700 °C, GDC 50 minutes, YSZ 30 minutes, GDC 15 minutes). A cathode was deposited by the PLD method using an LSC target (La_{0.6}Sr_{0.4}CoO_{3-δ}) sintered at 1200 °C (680 °C, 2 hours), so that a fuel cell including an internal reforming layer was manufactured.

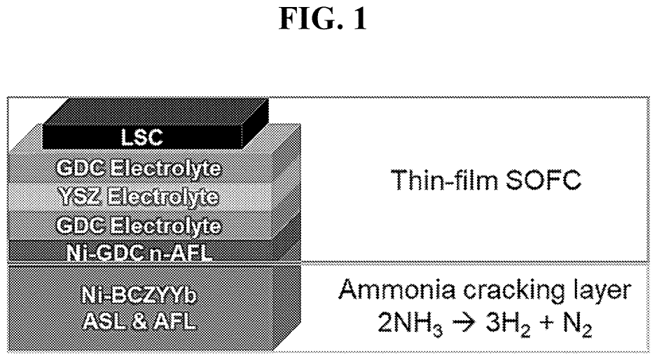

FIG. 1 is a schematic diagram showing a structure of a fuel cell according to one embodiment of the present invention.

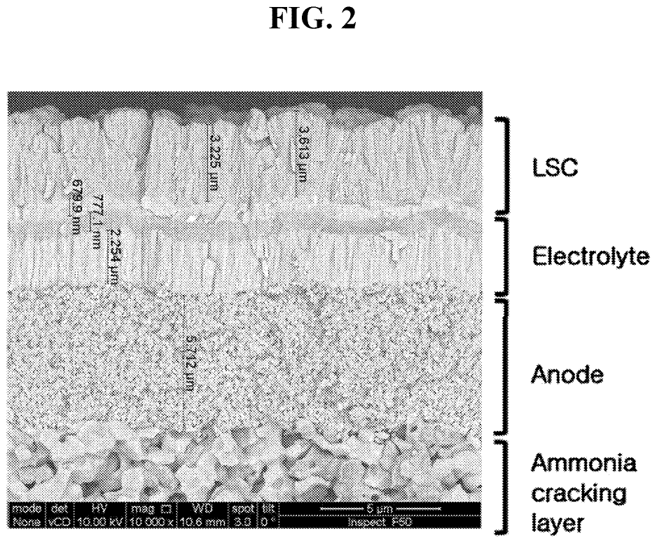

FIG. 2 is a field emission scanning electron microscope (FE-SEM) image of a structure of a fuel cell according to one embodiment of the present invention.

### <Reference Example>Manufacture of Porous Support for Fuel Cell

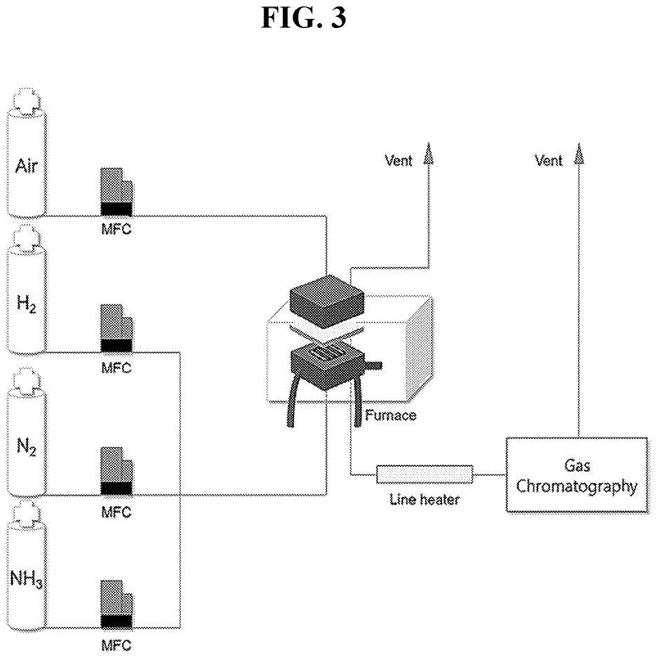

FIG. 3 is a schematic diagram showing an electrochemical performance evaluation and ammonia decomposition performance evaluation method of a fuel cell according to one embodiment of the present invention.

Air was injected into a cathode of the manufactured fuel cell, and hydrogen, a hydrogen-nitrogen mixed gas, or ammonia was injected into an anode, so that ammonia decomposition performance was evaluated. The hydrogen-nitrogen mixed gas was flowed at a ratio of hydrogen:nitrogen=3:1 assuming a case where ammonia is 100% converted.

For the manufactured cell, evaluations were conducted at 600 °C, 550 °C, and 500 °C while changing gases (hydrogen, hydrogen-nitrogen mixed gas, or ammonia). Evaluation conditions were evaluated by setting cathode air 200 sccm/anode hydrogen 200 sccm, hydrogen 150 sccm-nitrogen 50 sccm, and ammonia 100 sccm for each temperature. A conversion rate of ammonia was measured by directly connecting a rear end discharge pipe of the anode to gas chromatography (GC).

### <Experimental Example 1>Ammonia Decomposition Performance Evaluation of Fuel Cell

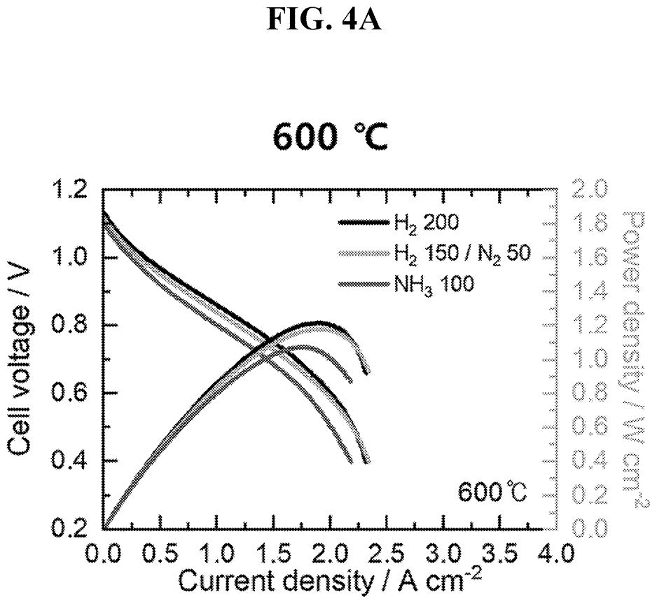

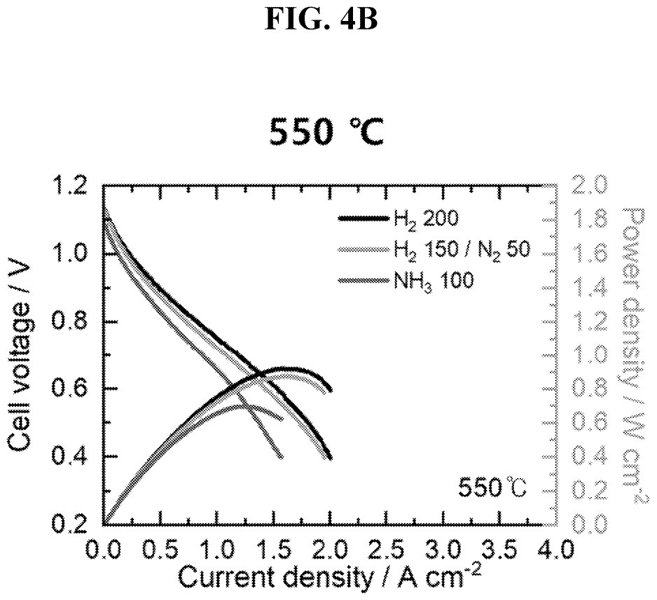

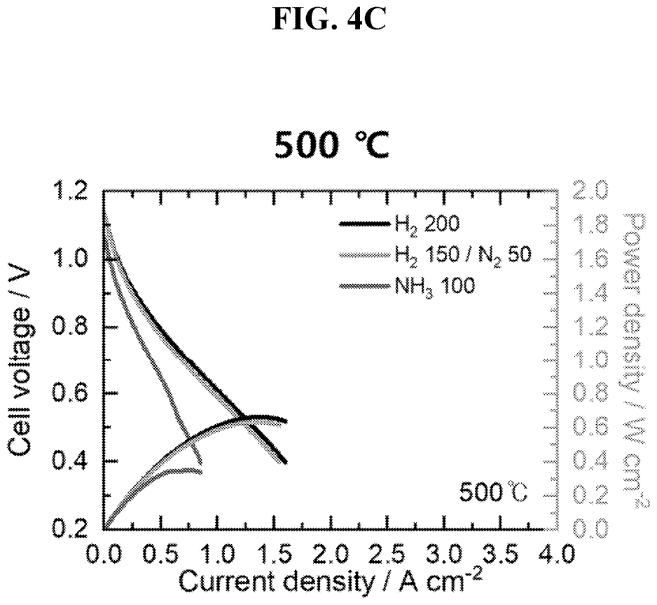

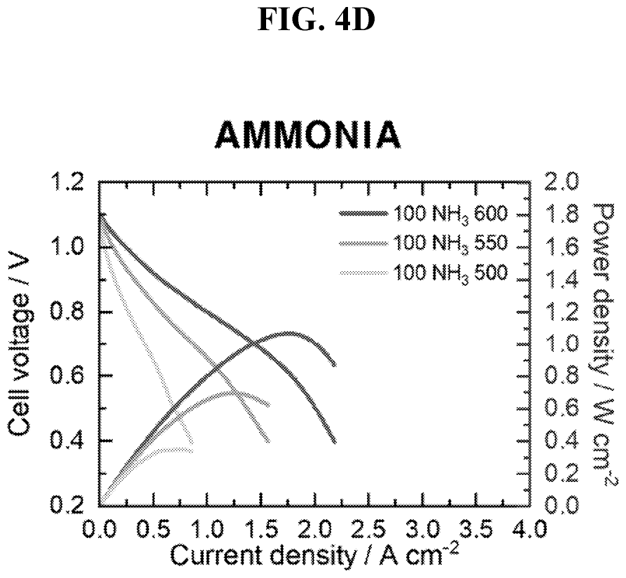

Ammonia decomposition performance of a fuel cell according to one embodiment of the present invention was evaluated. FIGS. 4A to 4D are graphs showing results of evaluating performance of a fuel cell under various fuel conditions according to one embodiment of the present invention.

As a result of conducting evaluations for the manufactured cell at 600 °C, 550 °C, and 500 °C while changing gases, similar performance was shown when hydrogen and the hydrogen-nitrogen mixed gas were flowed (hydrogen: black line, hydrogen-nitrogen: blue line).

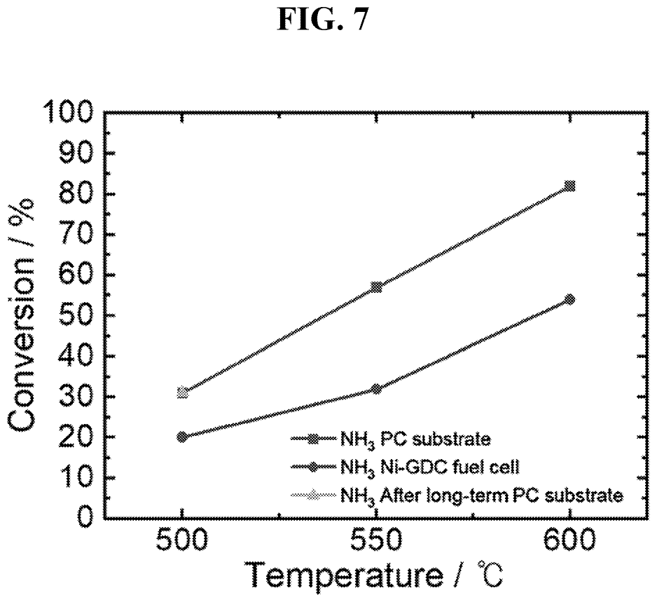

When ammonia was flowed, a gap with hydrogen performance was shown as temperature was lowered, and this is because, as shown in FIG. 7, the ammonia decomposition performance decreased as the temperature was lowered (ammonia: green line). When ammonia was flowed at 600 °C, a maximum power density of 1074 mW/cm² was achieved, indicating high performance.

For this cell, it can be confirmed that high performance was achieved only by introducing the Ni-BCZYYb 4411 internal reforming layer without applying an additional catalyst.

### <Experimental Example 2>Long-Term Driving Evaluation of Fuel Cell

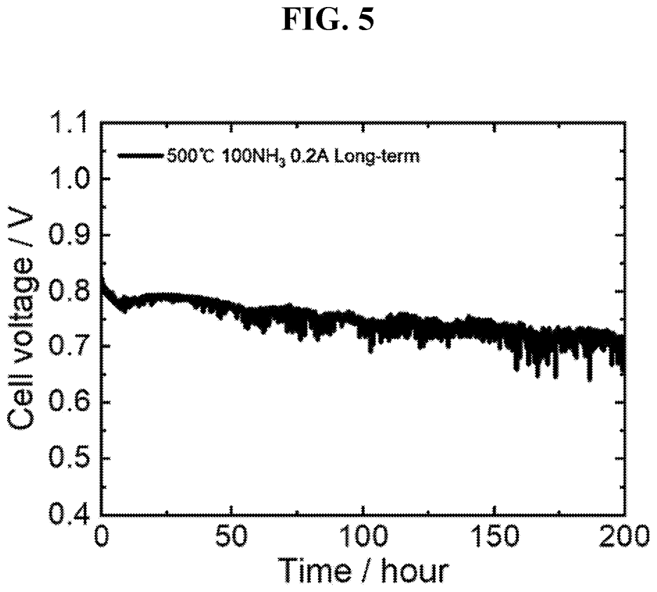

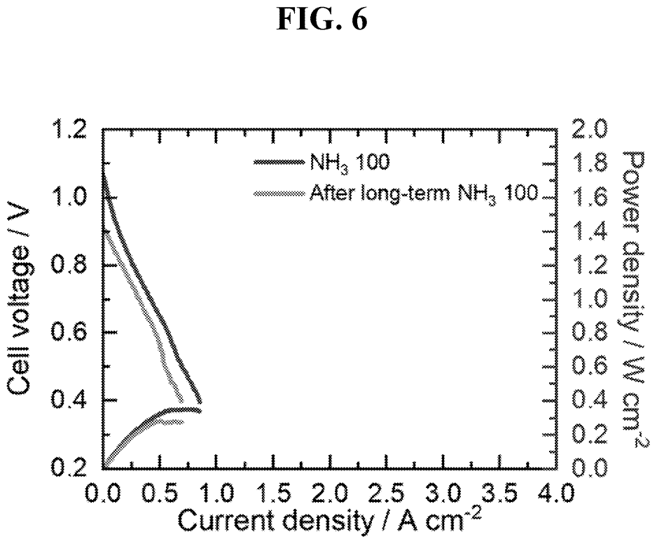

Long-term driving of a fuel cell according to one embodiment of the present invention was evaluated. A 200-hour long-term driving evaluation was conducted at 0.2 A at 500 °C and ammonia 100 sccm. FIG. 5 is a graph showing long-term driving evaluation results of a fuel cell according to one embodiment of the present invention. FIG. 6 is a graph showing fuel cell performance evaluation results before and after long-term driving evaluation of a fuel cell according to one embodiment of the present invention.

After the 200-hour long-term evaluation, a voltage showed a deterioration rate of 56.7%/kh from 0.803 V to 0.712 V. After the 200-hour long-term evaluation, performance showed a performance reduction rate of 20% from 351 mW/cm² to 283 mW/cm².

### <Experimental Example 3>Ammonia Decomposition Performance Evaluation of Fuel Cell

Ammonia decomposition performance of a fuel cell according to one embodiment of the present invention was evaluated. A conversion rate when ammonia was flowed at 600 °C, 550 °C, and 500 °C was measured by gas chromatography (GC). FIG. 7 is a graph showing ammonia decomposition performance evaluation results of a fuel cell according to one embodiment of the present invention.

In a case of a Ni-GDC cell using a Ni-YSZ anode support without the Ni-BCZYYb 4411 internal reforming layer, a low ammonia conversion rate was shown. This cell showed a high ammonia decomposition rate of 82% at 600 °C (550 °C: 57%, 500 °C: 31%). When a conversion rate was measured after the 200-hour long-term evaluation at 500 °C, it showed the same value as the conversion rate before the long-term (500 °C after 200 hours: 31%).

While exemplary embodiments of the present invention have been described above with reference to the above-mentioned preferred embodiments, various modifications and alterations may be made without departing from the subject matter and the scope of the invention. Accordingly, the appended claims include the modifications or alterations as long as the modifications or alterations fall within the subject matter of the present disclosure.

What is claimed is:

1. A porous support for a fuel cell, comprising an internal reforming layer coupled to an anode of a fuel cell to reform fuel provided to the anode, and having a Ni-BCZYYb skeleton.

2. The porous support for a fuel cell of claim 1, wherein a CZYYb composition ratio (Ba:Ce:Zr:Y:Yb) of the Ni-BCZYYb is 10:1 to 10:1 to 10:1: 1.

3. The porous support for a fuel cell of claim 1, wherein a BCZYYb composition ratio (Ba:Ce:Zr:Y:Yb) of the Ni-BCZYYb is 10:4: 4: 1: 1.

4. The porous support for a fuel cell of claim 1, wherein the Ni-BCZYYb is Ni-BaCe_{0.4}Zr_{0.4}Y_{0.1}Yb_{0.1}O₃.

5. The porous support for a fuel cell of claim 1, wherein the fuel is ammonia or a gas in which ammonia is partially reformed.

6. The porous support for a fuel cell of claim 1, wherein the internal reforming layer does not comprise an additional catalyst other than Ni-BCZYYb.

7. A fuel cell, in which an oxygen ion conductive solid oxide fuel cell is formed on the porous support for a fuel cell according to claim 1.

8. A fuel cell, in which an oxygen ion conductive solid oxide fuel cell is formed on the porous support for a fuel cell according to claim 4.
